(19) United States
(12) Patent Application Publication
(10) Pub. No.: US 2010/0018643 A1
(43) Pub. Date: Jan. 28, 2010

(54) Method And Apparatus For Mounting A Piece Of Foil On A Substrate

(76) Inventors: Roland Kuster, Urdorf (CH); Andreas Niffeler, Rotkreuz (CH); Martin Von Arx, Unteraegeri (CH)

Correspondence Address: Nixon Peabody LLP, P.O. Box 60610, Palo Alto, CA, 94306, US

(21) Appl. No.: 12/359,260

(22) Filed: Jan. 23, 2009

Related U.S. Application Data
(60) Provisional application No. 61/062,360, filed on Jan. 25, 2008.

(51) Int. Cl. B32B 38/04

(52) U.S. Cl. 156/256; 156/521

(57) ABSTRACT

An apparatus for mounting a piece of foil on a substrate comprises a holder for receiving a strip of foil which is wound up on a roll, a loop buffer, an alignment unit in which the strip of foil is guided between two parallel plates and is deflected at least twice, a feed unit for the intermittent feeding of the strip of foil and a cutting unit for cutting a piece of foil. The cutting unit comprises two blades which touch each other in a contact point in order to cut the piece of foil.

### PRIORITY CLAIM

Applicant hereby claims the benefit of priority of U.S. Provisional Patent Application Ser. No. 61/062,360 filed on Jan. 25, 2008, the disclosure of which is herein incorporated by reference.

### FIELD OF THE INVENTION

The invention relates to a method and an apparatus for mounting a piece of foil on a substrate. Such a foil is known in the field as film or tape.

### BACKGROUND OF THE INVENTION

In order to fasten semiconductor chips (which are known in the field as dies) on a substrate, liquid adhesives, so-called epoxy resins, are mostly used. In some applications, a piece of foil is used instead of the liquid adhesive in order to fasten the semiconductor chip to the substrate. The substrate may also be a semiconductor chip that has already been mounted on another substrate in the so-called stack-die application. These mounting processes are known as “film processes”. The foil can additionally be used as a spacer. The present invention relates to a mounting process in which a piece of foil is placed on the substrate in a first step and the semiconductor chip is placed on the foil in a second step. Such mounting processes are known for example from the patents U.S. Pat. No. 6,099,678, U.S. Pat. No. 6,742,561, U.S. Pat. No. 6,825,249.

### BRIEF DESCRIPTION OF THE INVENTION

The invention is based on the object of developing such a mounting process which allows cutting off piece by piece at a high cycle speed from a strip of foil wound up on a roll, with the length of the pieces of foil fluctuating only very little, and placing the pieces of foil with high precision on the substrate.

The object of the invention is solved by a method for mounting a piece of foil on a substrate, the method comprising:

providing a strip of foil wound up on a roll,

passing the strip of foil through a loop buffer,

guiding the strip of foil in an alignment unit between two parallel, vertically arranged plates and deflecting the strip of foil in the alignment unit at least twice,

feeding the strip of foil to a feed unit,

advancing the strip of foil intermittently by means of the feed unit,

guiding the strip of foil after the feed unit between two horizontally arranged plates,

cutting a piece of foil off from the strip of foil by means of two cooperating blades of a cutting unit, and

placing the piece of foil on a substrate.

An apparatus for mounting a piece of foil on a substrate according to the invention comprises:

a holder for receiving a roll with a strip of foil wound on the roll,

a feed unit for intermittently forward feeding the strip of foil,

a cutting unit for cutting a piece of foil, the cutting unit comprising a clamping blade and a cutting blade which touch each other in a contact point,

a loop buffer, and

an alignment unit in which the strip of foil is guided between two parallel plates and is deflected at least twice,

the loop buffer and the alignment unit arranged between the holder and the feed unit.

The apparatus further comprises advantageously a guide unit arranged between the feed unit and the cutting unit, the guide unit comprising a horizontally aligned support plate and a horizontally arranged cover plate which are arranged at a distance from each other. An edge of the cover plate facing the cutting unit is preferably bent off, so that the edge extends under a predetermined angle inclined to the direction of feed of the strip of foil.

The apparatus preferably further comprises a foil mounting unit and a table displaceable back and forth between two positions, the table cooperating in the one position with the clamping blade of the cutting unit in order to clamp the strip of foil during the cutting and the table presenting in the other position the cut piece of foil to the foil mounting unit.

The apparatus preferably further comprises an image processing system comprising a single camera and a deflection system with a semitransparent mirror, a mirror and an optical switch, the deflection system alternatingly setting up a first or a second visual field for the camera, with the piece of foil provided on the table being situated in the first visual field and the substrate place on which the piece of foil is to be placed being situated in the second visual field.

### BRIEF DESCRIPTION OF THE DRAWING FIGURES

The accompanying drawings, which are incorporated into and constitute a part of this specification, illustrate one or more embodiments of the present invention and, together with the detailed description, serve to explain the principles and implementations of the invention. The figures are not to scale. In the drawings:

FIG. 1 shows a side view of a module for mounting pieces of foil on a substrate;

FIG. 2 shows an alignment unit of the module in a top view;

FIG. 3 shows a table, a foil mounting unit and an image processing system of the module in a top view;

FIG. 4 shows a guide unit of the module in a top view;

FIG. 5 shows two blades of a cutting unit of the module in a side view on an enlarged scale;

FIGS. 6 to 8 illustrate a process for cutting a piece of foil from a strip of foil, and

FIG. 9 shows the image processing system in a side view.

### DETAILED DESCRIPTION OF THE INVENTION

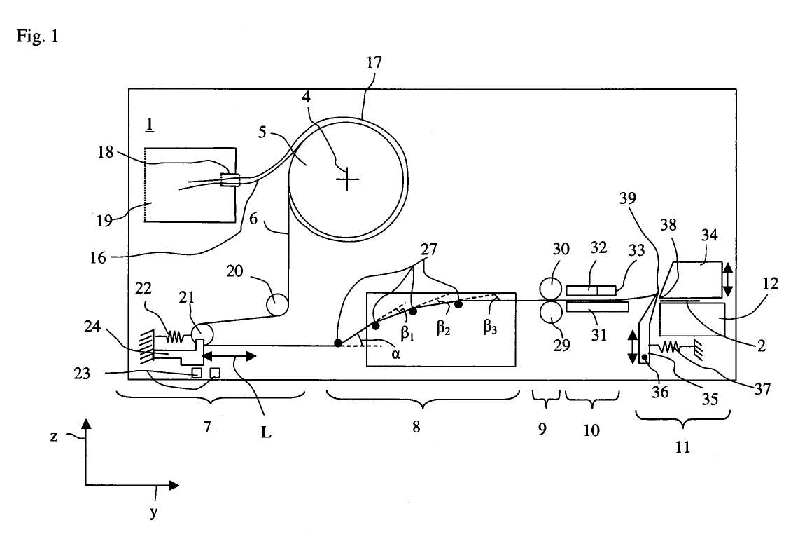

FIG. 1 shows a side view of a module 1 for the mounting of pieces of foil 2 on a substrate 3 (FIG. 3), which module 1 can be inserted in a die bonder. The coordinate axes of a Cartesian coordinate system are designated with x, y and z, with the x-direction extending perpendicular to the projection plane and the z-direction extending in the vertical direction. The substrates 3 are transported by a transport device (not shown) intermittently in the x-direction. Module 1 is held in the die bonder to be displaceable in the y-direction, so that it is conveniently accessible to the operator and can be operated in a simple way. Module 1 contains the following sub-units which are arranged in the following sequence: a holder 4 for receiving a roll 5 with a strip of foil 6, a loop buffer 7, an alignment unit 8 for aligning the strip of foil 6, a feed unit 9, a guide unit 10, a cutting unit 11, a table 12 which can be moved in a reciprocating manner between two positions A and B (FIG. 3), and a foil mounting unit 13 with a bonding head 14 and an image processing system 15. The foil to be applied to the substrate 3 can be wound up on roll 5 with no, one or two protective foils 16, 17. The protective foils prevent adherence of the foil during storage and need to be removed. Module 1 is additionally configured to dispose of such protective foils, such that the protective foils are wound up on rolls as shown in U.S. Pat. No. 7,096,914, or in such a way that, as illustrated, a Venturi nozzle 18 which can be supplied with compressed air produces a suction which draws the protective foil into an air-permeable collecting container 19. Collecting container 19 preferably comprises a wall that is formed as a perforated plate. When the strip of foil 6 is protected with an upper protective foil 16 and a bottom protective foil 17, the bottom protective foil 17 can be detached at the beginning of the strip of foil 6, wound once about the roll 5 (for reasons of clarity of the illustration the protective foil 17 is shown in FIG. 1 to be guided loosely about roll 5), and can then be guided with the upper protective foil 16 together through the Venturi nozzle 18 to the collecting container 19.

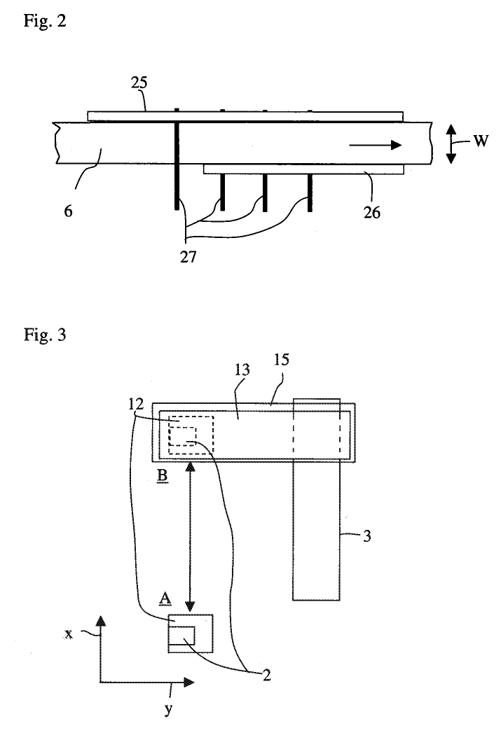

FIG. 2 shows the alignment unit 8 in a top view. The direction of feed of the strip of foil 6 is indicated by an arrow. The distance between the plates 25 and 26 is adjusted to the width W of the strip of foil 6.

FIG. 3 shows the table 12, the foil mounting unit 13 and the image-processing system 15 in a top view. The table 12 is shown twice, once with an unbroken line in position A and with a broken line in position B. In position A, table 12 is located beneath the clamping blade 34 (not shown) of the cutting unit 11 (FIG. 1).

The cutting process requires a discontinuous feed of the strip of foil 6, which also needs to be performed very rapidly in order to enable a high cycle frequency. During direct unwinding, high tensile stresses may occur in the strip of foil 6. This may lead to the risk that the strip of foil 6 may tear. The loop buffer 7 ensures that the strip of foil 6 is always slightly tensioned from the roll 5 to the feed unit 9 and prevents tearing of the strip of foil 6 in this way. The loop buffer 7 uncouples the intermittent forward feed of the strip 6 from the inert roll 5 which is caused by the feed unit 9. This allows the feed unit 9 to provide a very rapid (jerky) feed of the strip of foil 6 without having the tensile stress in the strip of foil 6 exceeding a predetermined amount. The approximately even tension in the strip of foil 6 which is caused by the loop buffer 7 also facilitates the precise alignment of the strip of foil 6.

The loop buffer 7 comprises two deflection rollers, which are a stationary arranged deflection roller 20 and a deflection roller 21 which is held in a displaceable manner along the travel path L, with the deflection roller 21 being pulled by a spring 22 in a predetermined direction, which extends preferably horizontally as shown in the example, in order to tension the strip of foil 6 which is wound up on the one side of the loop buffer 7 on roll 5 and is held on the other side of the loop buffer 7 by the feed unit 9. The movable deflection roller 21 is advantageously displaceable in the horizontal direction.

When friction and torque of the deflection roller 21 are negligibly small, tensile stress F_{T} in the strip of foil 6 is given approximately by:

$${F}_{T} = \frac{1}{2} F + \frac{1}{2} m * a$$

with quantity F designating the tensile force of spring 22, the quantity m the mass of the displaceable deflection roller 21 and quantity a the feed acceleration of the strip of foil 6. In order to ensure that the strip of foil 6 is always tensioned during a feed caused by the feed unit 9, the following equation should be fulfilled:

F>−m*a

At a mass of the deflection roller 21 of m=15 g, a maximum acceleration of the strip of foil 6 of a=50 m/s², a maximum deceleration of the strip of foil 6 of a=−50 m/s² and a tensile force of the spring 22 of F=1N in the strip of foil 6, a tensile stress F_{T} is obtained which always lies in the range of between 0.125N and 0.875N. Tensile stress F_{T} is therefore upwardly limited and preferably always larger than zero.

In an especially preferred embodiment, the strip of foil 6 slides in a contactless manner on the deflection roller 21. This can be achieved in such a way for example that the contact surface of deflection roller 21 comprises channels through which a fluid, e.g. air, can be pressed, so that the strip of foil 6 will slide on a fluid cushion.

During the time between two feeds, the roll 5, which due to its mass has a much larger inertia than the deflection roller 21, can wind off so much strip of foil 6 with lower accelerations and speeds that the deflection roller 21 remains in an initial position on average time. The unwinding of the strip of foil 6 from the roll 5 and the feed of the strip of foil 6 by means of the feed unit 9 can overlap in progression over time.

The unwinding of the strip of foil 6 from the roll 5 can occur in different ways, on the one hand passively by advancing the strip of foil 6 only with the feed unit 9 and on the other hand in that a motor rotates the roll 5 continuously or in a sensor-controlled manner. The sensor can comprise two stationary mounted light barriers 23 (FIG. 1) and a flag 24 which is fastened to the deflection roller 21 and which interrupts or leaves open the light barriers 23 depending on the position of the deflection roller 21. For reasons of clarity of the illustration, light barriers 23 are shown in FIG. 1 in an offset manner beneath the flag 24. The light barriers 23 supply a binary signal 0 or 1, with 0 meaning that the light barrier is open and 1 meaning that the light barrier is interrupted by flag 24. The travel path of the deflection roller 21 or its flag 24 is limited by stops, so that the signals 00, 01, 10 and 11 supplied by the light barriers 23 define four unique positional areas of the deflection roller 21 with the following meaning:
State 10: There is no tensile stress in the strip of foil 6. This means that the end of the strip of foil 6 is either not fixed to the roll 5 and the roll 5 is empty or the strip of foil 6 has torn.
State 11: Loop buffer 7 is filled with strip of foil 6. This means that the unwinding from roll 5 can be stopped.
State 01: The loop buffer 7 is nearly empty. This means that the strip of foil 6 has already been advanced and the unwinding from roll 5 should be commenced.
State 00: The flag has traveled beyond the two light barriers 23. This means that there is a larger tensile stress in the strip of foil 6 than is foreseen for production. This occurs when the end of the strip of foil 6 is fastened to the roll 5 and the strip of foil 6 has been used up.

The alignment unit 8 for the alignment of the strip of foil 6 comprises two plates 25 and 26 which extend in the yz-plane and are arranged parallel with respect to each other, as well as several pins 3 on which the strip of foil 6 is deflected. The one plate 25 is arranged in a stationary way, the other plate 26 is arranged to be displaceable and arrestable, so that the distance between the two plates 25 and 26 can be adjusted to different widths of the strip of foil 6. There are at least two pins that are present (there are four pins 27 in the example) whose z-position increases from pin to pin, so that strip of foil 6 tensioned over the four pins 27 is bent at the first pin about the angle α and in the second, third and fourth pin by the angle β₁, β₂ and β₃, respectively. Preferably, β₁=β₂=β₃. If the strip of foil 6 is to have the same direction before and after the alignment unit 8, α+β₁+β₂+β₃=0. This bending of the strip of foil 6 prevents that the strip of foil 6 can twist about its longitudinal direction. The movable plate 26 comprises holes 28 through which the pins 27 protrude. The movable plate 2 does not cover the first pin 3 because this would impair threading of the strip of foil 6.

The feed unit 9 comprises a drive roll 29 and a press roll 30. The drive roll 29 is rotated during each feed by the angle which advances the strip of foil 6 by the desired length. The drive roll 29 can be provided with a special adhesive layer in order to prevent slippage of the strip of foil 6 during the forward feed. The press roll 30 presses the strip of foil 6 with an adjustable force against the drive roll 29. Press roll 30 is preferably rotatable about the z-direction, so that its alignment can be readjusted slightly relative to the alignment of the drive roll 29. Moreover, the press roll 30 can be moved away from the drive roll 29 in order to facilitate the threading of the strip of foil 6.

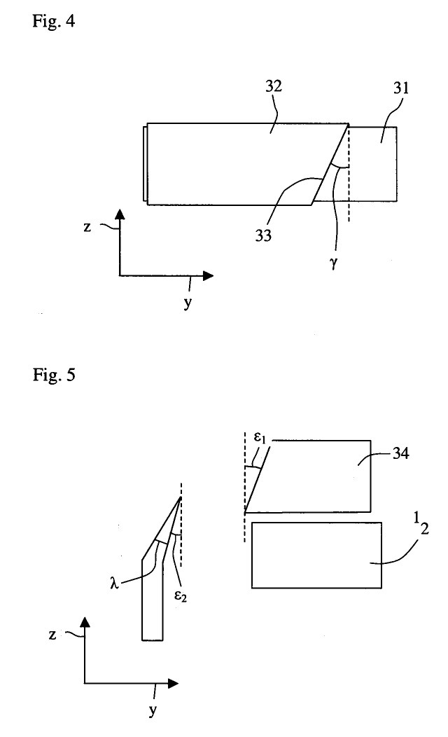

The guide unit 10 comprises a stationary arranged support plate 31 and a removable cover plate 32. These two plates are arranged at a slight distance from each other and parallel to each other in horizontally extending planes, which means they extend parallel to the xy-plane. The guide unit 10 prevents a bulging of the strip of foil 6 in the area between the feed unit 9 and the cutting unit 11. FIG. 4 shows the guide unit 10 in a top view. The edge 33 of the cover plate 32 facing the cutting unit 11 is bent off, so that the edge 33 extends under a predetermined angle γ in an inclined manner to the direction of forward feed of the strip of foil 6. This bending ensures that the strip of foil 6 can bend upwardly during cutting and thus prevents injury to the front edge of the strip of foil 6.

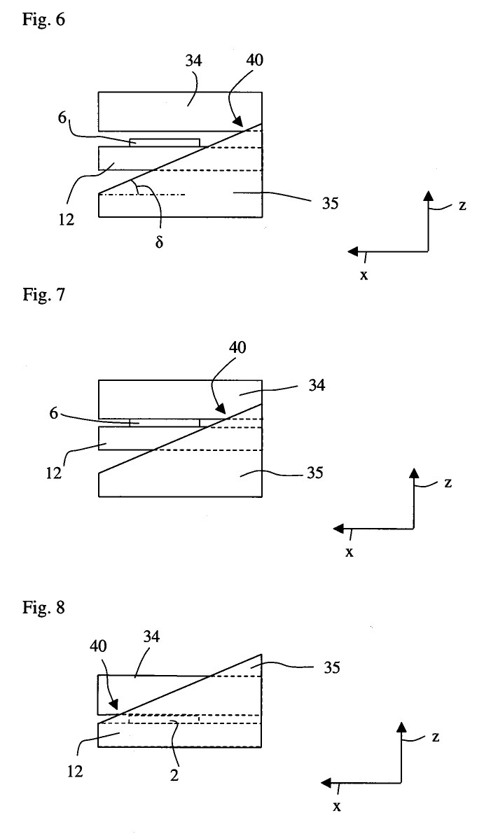

The cutting unit 11 comprises two blades, which are a clamping blade 34 and a cutting blade 35, with the clamping blade 34 cooperating with the table 12 in order to tightly clamp the strip of foil 6 during the cutting. The cutting blade 35 is rotatably held about a horizontally running axis 36 and is pressed by a spring 37 against the clamping blade 34. Both the clamping blade 34 and the cutting blade 35 are displaceable in the vertical direction, preferably in a pneumatic or electromechanical way, as illustrated in FIG. 1 with the arrows. Clamping blade 34 comprises a cutting edge 38 which extends in the horizontal direction, i.e. the x-direction, and which is inclined relative to the vertical by an angle ε₁. The cutting blade 35 comprises a cutting edge 39 which firstly is inclined against the horizontal by a predetermined angle δ (FIG. 6) and secondly is inclined on its side facing the clamping blade 34 against the vertical by an angle ε₂. The two angles ε₁ and ε₂ can be equally large. The cutting blade 35 is ground with a wedge angle λ of approximately 30° to 60°. Since the clamping blade 34 has a relief grinding of angle ε₁ and the cutting blade 35 has a relief grinding of angle ε₂, the two blades 34 and 35 are only in contact in a single contact point 40. The possibilities for movement of the two blades 34 and 35 in the vertical direction are limited in such a way that they will always contact each other at some place. The blades 34 and 35 preferably consist of very hard, abrasion-proof material like hard metal or ceramics and are preferably covered with a hardening layer which reduces friction such as an adamantine layer (e.g. BALINIT TRITON of Oerlikon Balzers) in order to increase their service life due to hardness and favorable sliding properties of such a layer.

Such coated blades are also suitable for use in other fields, especially for cutting paper pages within the scope of book printing. The coating prevents rapid wearing of the blades. Once a specific degree of wearing has been reached, a renewed coating can be applied. The blades can thus be recycled.

FIG. 5 shows the clamping blade 34 and the cutting blade 35 of the cutting unit 11 on an enlarged scale in a side view in order to illustrate the relief grindings produced by the angles ε₁ and ε₂.

The cutting unit 11 can be rotatably held about a vertical axis, so that the strip of foil 6 can be cut off under any random angle with respect to the longitudinal direction of the strip of foil 6. In this case, the cut pieces of foil have the shape of a parallelogram.

The cutting process will be explained by reference to FIGS. 6 to 8 in detail. Table 12 is brought to position A (FIG. 3) in which it is located beneath the clamping blade 34. The clamping blade 34 is situated in a lifted position and the cutting blade 35 is situated in a lowered position, with its contact point 40 being situated in the example on the right side of FIG. 6. The feed unit 9 pushes the strip of foil 6 over the programmed distance, so that the beginning of the strip of foil 6 reaches between the table 12 and the clamping blade 34. The table 12 is preferably arranged slightly lower than the support plate 31 of the guide unit 10, so that the front end of the strip of foil 6 does not push against table 12 and get stuck. The table 12 is additionally preferably arranged in the y-direction at a slight distance from the cutting blade 35 in order to avoid touching the cutting blade 35. The table 12 is subjected to a negative pressure in order to tightly hold the strip of foil 6. This state is shown in FIG. 6. In the next step, the clamping blade 34 is lowered to a lowered position in which the clamping blade 34 and the table 12 clamp the end of the foil. In the example, in doing so the contact point 40 travels to the left. This state is shown in FIG. 7. In the next step, the cutting blade 35 is lifted to a raised position. The contact point 40 of the two blades 34 and 35 travels further to the left: The cutting blade 35 cuts off the end of the foil, with the strip of foil 6 successively being bent upwardly, which is promoted by the aforementioned bending of edge 33 of the cover plate 32. This state is shown in FIG. 8. A piece of foil 2 has now been cut off. In the next step, the cutting blade 35 is lowered to the lowered position again and the clamping blade 34 is lifted to the raised position. In order to support the detachment of the cut foil from the clamping blade 34, the clamping blade 34 is preferably subjected to compressed air which blows the foil away from the clamping blade 34.

The mechanism of the cutting unit 11 allows a clean cut of the foil, with the blades 34 and 35 even sharpening themselves.

The table 12 is now brought to position B which is situated outside of the range of the clamping blade 34 and in which the cut piece of foil 2 is received by the bonding head 14 of the foil mounting unit 13 from the table 12 and can be placed on the substrate 3. To ensure that the piece of foil 2 can be placed in a precisely positioned manner on the substrate 3, the position of the piece of foil 2 presented on table 12 and the position of the substrate place are measured by means of the image-processing system 15. This embodiment with the table 12 displaceable between the positions A and B allows making the surface of the bonding head 14 that receives the piece of foil 2 slightly larger than the piece of foil 2. This enables even pressing of the piece of foil 2 on the substrate 3 over the entire surface area of the piece of foil 2 beyond its edge, which thus substantially reduces the likelihood of undesirable entrapments of air.

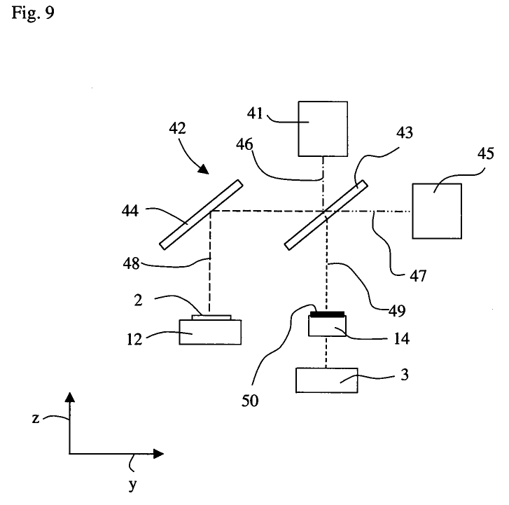

The image-processing system 15 is shown in FIG. 9. It advantageously comprises a single camera 41 which usually comprises an image capturing chip and a lens system, and a deflection system 42 which is used to alternatingly set a first or second visual field for camera 41, with the piece of foil 2 provided on the table 12 being situated in the first visual field and the substrate place on which the piece of foil 2 is to be placed is located in the second visual field. Camera 41 and the deflection system 42 are arranged in a stationary way. The deflection system 42 comprises a semitransparent mirror 43 and a mirror 44 as well an illumination unit 45. The two mirrors 43 and 44 are inclined by 45° relative to the vertical. The semitransparent mirror 43 acts as a beam splitter, with the camera 41 being situated in one partial beam 46 and the illumination unit 45 in the other partial beam 47 on the one hand, and with the table 12 with the piece of foil 2 being located in a partial beam 48 and the substrate place in a partial beam 49 on the other hand. The optical paths of the partial beams 48 and 49 are preferably equally long, so that it is not necessary to readjust the focus of the camera 41. The light emitted by the illumination unit 45 illuminates both the table 12 with the piece of foil 2 as well as the substrate place thanks to the semitransparent mirror 43. An optical switch such as a preferably black piece of sheet metal 50 which is arranged at the top of the bonding head 14 interrupts the partial beam 48 when the bonding head 14 is located above the table 12 and interrupts the partial beam 49 (as illustrated) when the bonding head 14 is located above the substrate 3. When the bonding head 14 is moved back and forth from a position above the table 12 to a position above the substrate 3, the visual field of camera 41 changes automatically. Since the piece of sheet metal 50 is black, it is not recognizable to the camera 41 as an object despite the illumination by the illuminating unit 45. While the bonding head 14 picks up the piece of foil 2 from table 12, the camera 41 sees the substrate place and its position can be determined. While the bonding head 14 places the piece of foil 2 on the substrate place, the camera 41 sees the next piece of foil and its position can be determined.

An automatic changeover between the two visual fields can also be realized with two polarization filters, of which the one is arranged in the partial beam 46 in front of the camera 41 and the other is fastened to the bonding head 14 instead of the piece of sheet metal 50, with the two polarization filters being twisted relative to each other by 90°.

What is claimed is:

1. A method for mounting a piece of foil on a substrate, comprising
providing a strip of foil wound up on a roll,
passing the strip of foil through a loop buffer,
guiding the strip of foil in an alignment unit between two parallel, vertically arranged plates and deflecting the strip of foil in the alignment unit at least twice,
feeding the strip of foil to a feed unit,
advancing the strip of foil intermittently by means of the feed unit,
guiding the strip of foil after the feed unit between two horizontally arranged plates,
cutting a piece of foil off from the strip of foil by means of two cooperating blades of a cutting unit, and
placing the piece of foil on a substrate.

2. An apparatus for mounting a piece of foil on a substrate, comprising
a holder for receiving a roll with a strip of foil wound on the roll,
a feed unit for intermittently forward feeding the strip of foil,
a cutting unit for cutting a piece of foil, the cutting unit comprising a clamping blade and a cutting blade which touch each other in a contact point,
a loop buffer, and
an alignment unit in which the strip of foil is guided between two parallel plates and is deflected at least twice,
the loop buffer and the alignment unit arranged between the holder and the feed unit.

3. The apparatus according to claim 2, further comprising a guide unit arranged between the feed unit and the cutting unit, the guide unit comprising a horizontally aligned support plate and a horizontally arranged cover plate which are arranged at a distance from each other.

4. The apparatus according to claim 3, wherein an edge of the cover plate facing the cutting unit is bent off, so that the edge extends under a predetermined angle inclined to the direction of feed of the strip of foil.

5. The apparatus according to claim 2, further comprising
a foil mounting unit, and
a table displaceable back and forth between two positions, the table cooperating in the one position with the clamping blade of the cutting unit in order to clamp the strip of foil during the cutting and the table presenting in the other position the cut piece of foil to the foil mounting unit.

6. The apparatus according to claim 5, further comprising
an image processing system comprising
a single camera and a deflection system with a semitransparent mirror, a mirror and an optical switch, the deflection system alternatingly setting up a first or a second visual field for the camera, with the piece of foil provided on the table being situated in the first visual field and the substrate place on which the piece of foil is to be placed being situated in the second visual field.

7. The apparatus according to claim 3, further comprising
a foil mounting unit, and
a table displaceable back and forth between two positions, the table cooperating in the one position with the clamping blade of the cutting unit in order to clamp the strip of foil during the cutting and the table presenting in the other position the cut piece of foil to the foil mounting unit.

8. The apparatus according to claim 7, further comprising
an image processing system comprising
a single camera and a deflection system with a semitransparent mirror, a mirror and an optical switch, the deflection system alternatingly setting up a first or a second visual field for the camera, with the piece of foil provided on the table being situated in the first visual field and the substrate place on which the piece of foil is to be placed being situated in the second visual field.

9. The apparatus according to claim 4, further comprising
a foil mounting unit, and
a table displaceable back and forth between two positions, the table cooperating in the one position with the clamping blade of the cutting unit in order to clamp the strip of foil during the cutting and the table presenting in the other position the cut piece of foil to the foil mounting unit.

10. The apparatus according to claim 9, further comprising
an image processing system comprising
a single camera and a deflection system with a semitransparent mirror, a mirror and an optical switch, the deflection system alternatingly setting up a first or a second visual field for the camera, with the piece of foil provided on the table being situated in the first visual field and the substrate place on which the piece of foil is to be placed being situated in the second visual field.
